(19) United States
(12) Patent Application Publication
(10) Pub. No.: US 2012/0111283 A1
(43) Pub. Date: May 10, 2012

(54) Pet toy producing extended pressure released squeaking sound

(75) Inventor: Kyle Hansen, Castle Rock, CO (US)

(73) Assignee: The Kyjen Company, Inc.

(21) Appl. No.: 12/927,164

(22) Filed: Nov. 9, 2010

(51) Int. Cl. A01K 29/00

(52) U.S. Cl. 119/707

(57) ABSTRACT

The invention relates to a squeaking pet toy that is designed to perform in the reverse of the prior art toys wherein an extended squeaking sound is emitted after emission of intake air is forced through a reed vibrating squeaking device. The squeaking device is housed in a latex bladder which is designed to slowly inflate after compression and force air through the funnel end of the squeaking device causing an extended sound emission which retains the animal's attention and interest.

### FIELD

The invention relates to a novel pet toy wherein the toy comprises a latex bladder housing a squeaking device (squeaker), which, when the toy is depressed air is received into the squeaking device and extended sound is emitted upon exhalation of intake air as the bladder refills. The toy in this embodiment is encased in a latex bladder in the form of a bird, but may be shaped in any encasement form to aid in enticement of the animal.

### BACKGROUND OF THE INVENTION

The invention most closely corresponds with USPTO Class 119/702 wherein Class 119 relates to animal husbandry and sub-class 702 includes exercise or amusement devices for animals.

In its simplest form, the invention comprises a novel method of utilizing a squeaking device encased, for purposes of the embodiment herein, in a latex bird shaped enclosure (bladder) wherein as opposed to emitting sound upon depression of the toy, the inventive toy emits extended sound upon decompression of the bladder.

Current pet toys contain squeaker devices; however, the prior art toys emit sound when an animal compresses the toy. Typically this results in a short burst of sound. The inventive method is novel in two areas. The first is the emission of sound upon release of intake air being forced through the squeaking device as opposed to sound being emitted upon intake of air during initial compression. The second area of novelty is an extended squeaking sound which is longer than similar pet toys currently on the market.

### THE INVENTION

### Summary, Objects And Advantages

Pet toys are obviously created to entertain and teach pets, and their functionality is key in making the toys viable purchases for pet owners. The inventive toy utilizes the slow expansion of the latex bladder during emission of intake air after compression of the bladder. This allows for a long, slow, emission of sound which aids in entertainment of the animal. This novelty is of marketable value to pet owners who collectively purchase millions of dollars of pet toys per year.

Most squeaking pet toys are activated when a pet chews or presses on the toy. Upon some form of external pressure, the toy will emit a squeaking sound as air is forced into an internal squeaking device. The inventive toy employs a latex bladder which compresses when the animal applies pressure to the toy, and, when the bladder refills with air, that air is forced through the squeaker very slowly. This form of air emission is the reverse method utilized by current art toys, and allows for an extended sound emission which enhances the animal's interest in the toy.

Lab tests have shown the squeaking sound to last up to twenty (20) seconds upon release of intake air. This is at least double that of any current squeaking toy sound emission duration. Obviously, this extended stimulation serves to entertain the animal and aid in interest retention in the toy. Such a toy provides value for the purchase price paid by pet owners who do not desire to buy pet toys that either work poorly or in which an animal loses interest quickly.

For purposes of clear description, the inventive toy is described herein as being encased in a latex bladder in the shape of a bird. However, the inventive toy is not limited by the shape of the latex enclosure.

In summary, the inventive pet toy exhibits advantages and novelty over the art in that the design and functionality make this pet toy more stimulating for the pet, and a superior value for the purchase price by the pet owner.

### BRIEF DESCRIPTION OF THE DRAWINGS

The invention is described in further detail by reference to the drawings in which:

FIG. 1; depicts a view of the basic latex bladder shown encasing the squeaking device;

FIG. 2; illustrates the air flow pattern via which the extended squeaking sound is emitted; and

FIG. 3; illustrates the bottom portion of the squeaking device.

### DETAILED DESCRIPTION, INCLUDING BEST MODES OF CARRYING OUT THE INVENTION

The following detailed description illustrates the invention by way of example, not by way of limitation of the principles of the invention. This description will clearly enable one skilled in the art to make and use the invention, and describes various embodiments, adaptations, variations, alternatives, and uses of the invention. The description includes what are presently believed to be the best modes of carrying out the invention.

In this regard, the invention is illustrated in three relatively simple figures; although sufficiently complex as to illuminate to one skilled in the art of such software architecture, programming, and computer operations a viable method for making or using said invention.

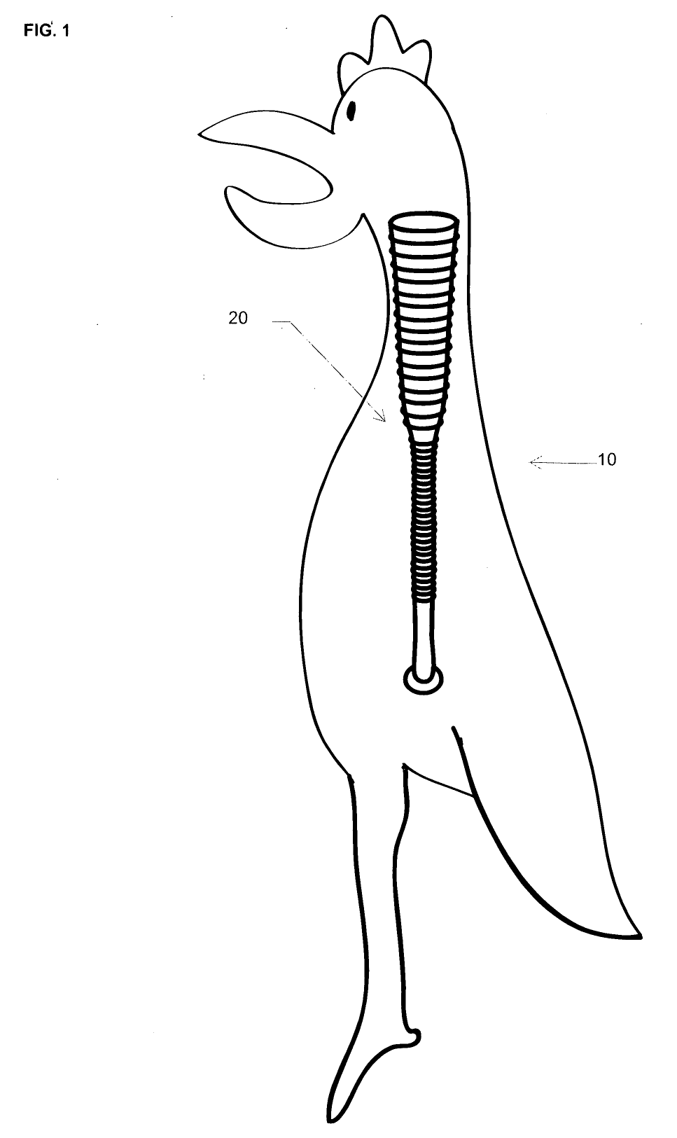

FIG. 1 depicts a simple illustration of the latex bladder 10 as in the shape of a bird as explained supra for ease of description. The squeaking device 20 is shown as simply housed within the latex bladder.

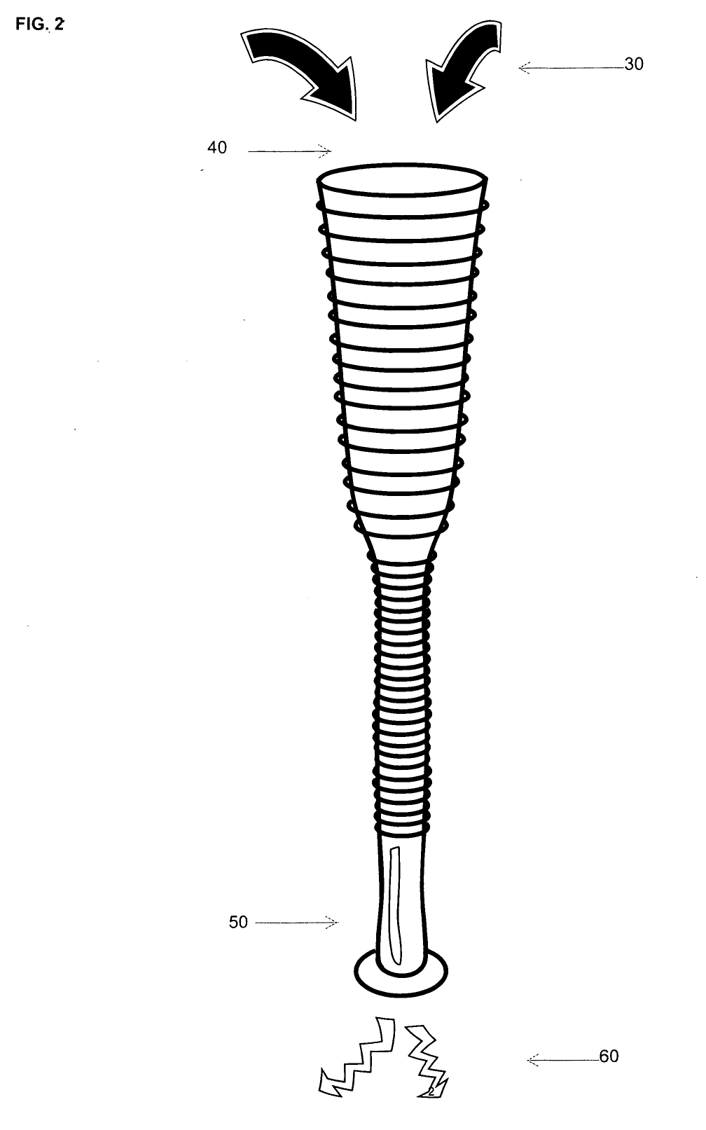

FIG. 2 is an illustration of the air flow process 30 as received via the funnel shaped end 40 of the squeaking device. The intake air then moves out the flanged end 50 of the squeaking device producing an extended emission of sound 60.

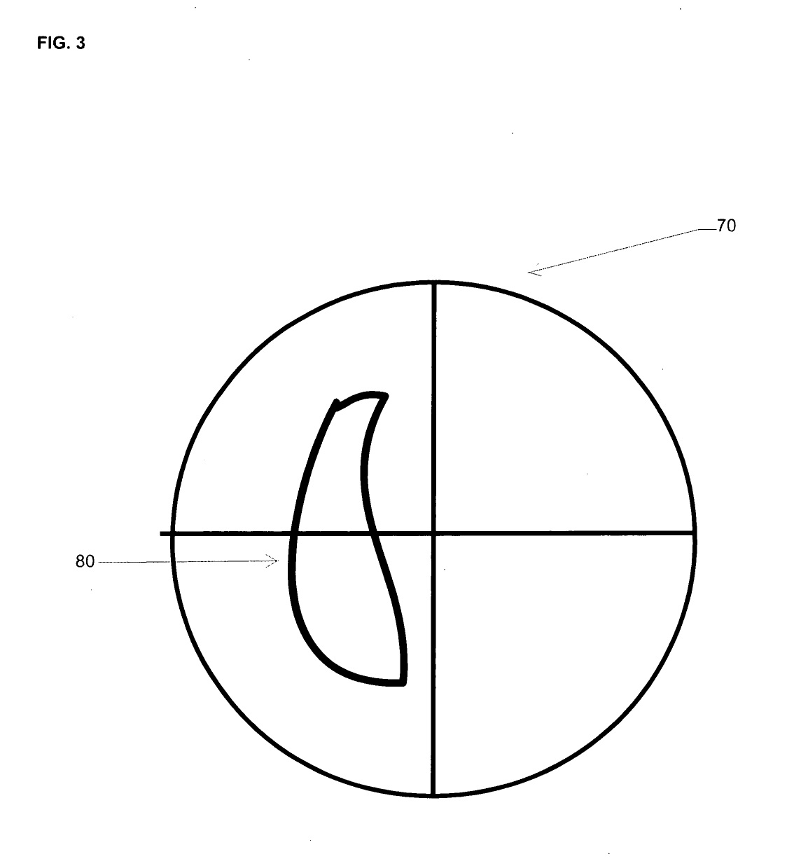

FIG. 3 is a very simple depiction of the bottom end of the squeaking device 70 showing the vibrating mechanism or reed 80 which ultimately creates the sound known as “squeaking”.

1) A squeaking pet toy producing an extended emission of sound upon air release after compression of the toy comprising:
a) a latex bladder
b) a vibrating reed squeaking device

2) The squeaking pet toy of claim 1 wherein the latex bladder is compressed and air is forced out of the bladder.

3) The squeaking pet toy of claim 1 wherein the bladder refills with air upon release of pressure thereupon.

4) The squeaking pet toy of claim 1 wherein the decompression of the latex bladder forces air into the funnel end of the squeaking device.

5) The squeaking pet toy of claim 1 wherein the forced air causes an extended squeaking sound to be emitted from the squeaking device.
